(19) United States
(12) Patent Application Publication
(10) Pub. No.: US 2013/0086766 A1
(43) Pub. Date: Apr. 11, 2013

(54) Attachable windshield wiper system for a helmet

(71) Applicants: Derrick André Allen, Killeen, TX (US); Cleophus Calloway Lewis, Killeen, TX (US)

(72) Inventors: Derrick André Allen, Killeen, TX (US); Cleophus Calloway Lewis, Killeen, TX (US)

(21) Appl. No.: 13/068,578

(22) Filed: Oct. 7, 2011

(51) Int. Cl. B08B 13/00

(52) U.S. Cl. 15/250.3

(57) ABSTRACT

The invention is an attachable and detachable windshield-wiper assembly for a windshield and/or windscreen and/or fairing and/or aeroscreen of an open canopy vehicle such as a motorbike and/or snowmobile and/or boat. The assembly can be fastened to a variety of windshield. The backside of the assembly has means of which to conform to the contours of the windshield and ensure a close fit. The assembly is secured to the windshield by means of fasteners such as screw and/or latch systems requiring minimal tools. The automated assembly will contain an electric motor with multiple speed settings and gearing connected to the motor to drive the wiper blade arm that protrudes through an opening in the assembly. The wiper blade arm will hold a readily available off-the-shelf wiper blade, which exists in different sizes for different windshields.

### BACKGROUND OF THE INVENTION

The invention is for creating an attachable and detachable windshield-wiper assembly for a windshield of an open canopy vehicle and relates to a normal windshield wiping apparatus. It is known that there are wiper assemblies that are irremovable from the vehicle. Additionally, there are wipers for windshields which vary in size and shape. There are also mobile wiper-systems that may be operated manually to clear water and/or debris. This invention addresses the need to be able to attach an automated device when riding through rain, snow, mud, etc. and detach the automated device when riding conditions become clear.

### SUMMARY OF THE INVENTION

It is one object of this invention to clear debris or precipitation from the windshield of an open canopy vehicle such that the view of the vehicle operator is unobstructed.

Another object of this invention is to provide an assembly that can be attached and detached as desired by the vehicle operator.

It is a further object of this invention for the power and gear components to be housed in a compact case for minimal drag on the assembly.

Other objects and features of the invention will become apparent within the following description of the invention.

The invention provides an attachable wiper assembly for the windshield of an open canopy vehicle that includes:
a case with a contoured back secured by a screw and/or latch system fastening the assembly around the open edge of the windshield;
a battery powered DC motor with a worm and worm gear connected to a linkage and wiper arm such that the wiper arm may oscillate;
a wiper arm that contains a pin joint torsion spring to apply force to the wiper as it traverses the windshield;
a pin joint between the wiper arm and wiper blade support that allows for free rotation as required by the contour of the windshield;
the means to activate and deactivate the motion of the wiper as well as adjust the speed; and the means to power wiper device by vehicle battery.

It is to be noted that this specification of the invention contains no new matter in relation to the previous iterations.

### BRIEF DESCRIPTION OF THE DRAWINGS

To better understand the operation and use of the invention, it will be described by the following drawings:

FIG. 1 is a front elevation view of the invention;

FIG. 2 is an internal front elevation view of the case assembly whereas the case lid is removed;

FIG. 3 is a side elevation view of the case assembly depicting the method of attachment;

FIG. 4 is a rear perspective view of the wiper and wiper arm assembly.

### DETAILED DESCRIPTION OF THE INVENTION

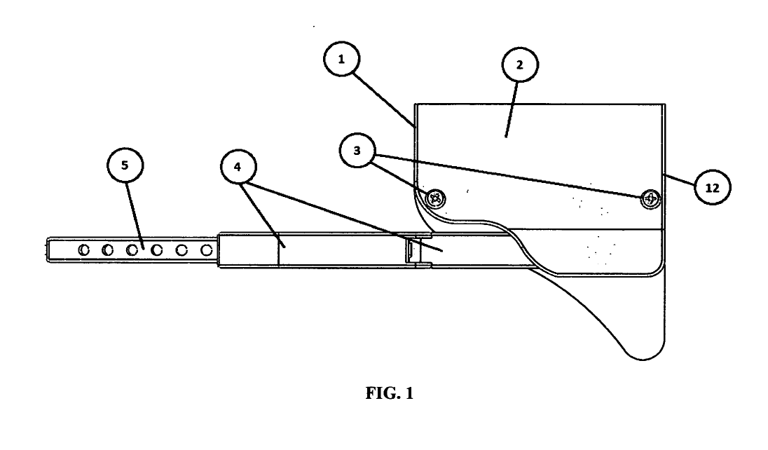

Referring to FIG. 1 of the drawings, there is shown the device as it would appear from the outside of the vehicle. The components within the case body 1 are protected by a lid 2 which is secured with screws 3. The case body 1 is affixed with a rubber backing 12 to conform to the geometry of the windshield and prevent abrasion. The blade assembly, consisting of the wiper arm 4 and the blade support 5, protrudes from the case body 1 and contacts the windshield.

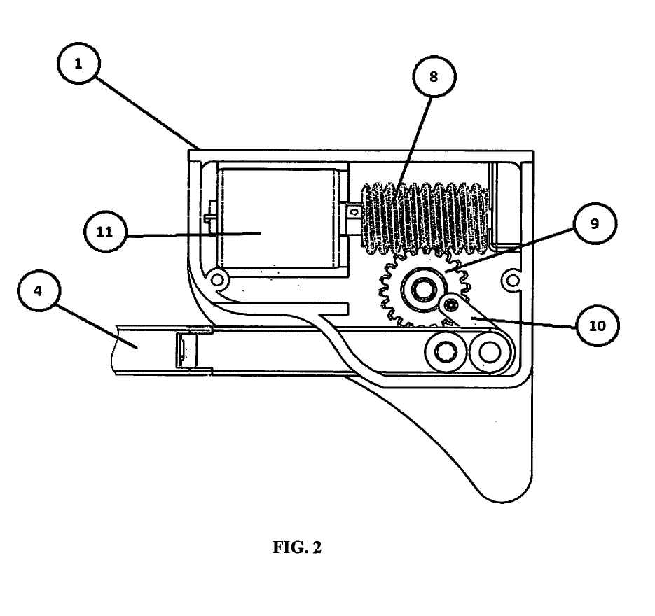

Referring to FIG. 2 of the drawings, there is shown the power transmission components of the invention. Beginning with the DC motor 11 to which a worm 8 is attached and thus drives a worm gear 9. A linkage 10 is attached to the worm gear 9 by a pin joint to allow for rotation during operation. Subsequently the wiper arm 4 is powered by the linkage 10 and the two are connected by another pin joint. The wiper arm 4 is also attached to the case body 1 by means of a pin joint such that the blade assembly may have sufficient range of motion across the windshield.

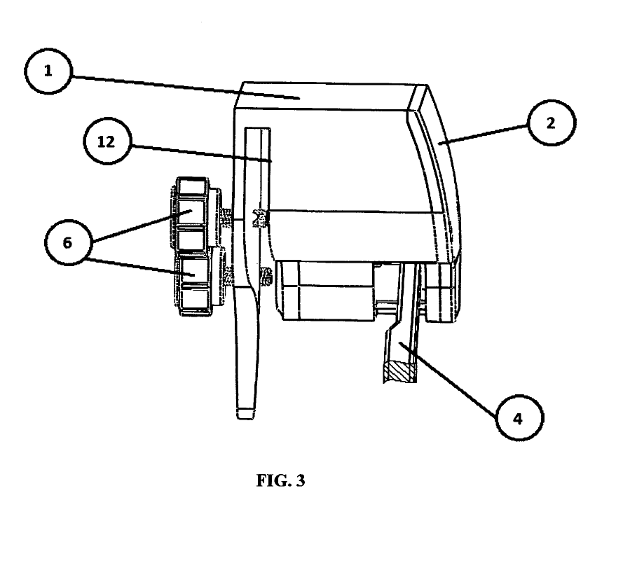

The side view of the case body 1 depicted in FIG. 3 details the means of attaching the invention. To better understand the orientation of FIG. 3 it should be understood the case lid 2 is the exterior facing surface of the device and from the case body 1 protrudes the wiper arm 4 and blade assembly, which will operate on the exterior surface of the windshield. The method of attachment consists of two knobs-with-threaded-studs 6, which are threaded through a back plate extrusion of the case body 1. These knobs-with-threaded-studs 6 allow the operator to apply a compressive force from the interior of the windshield and effectively secure the device with the additional grip and conforming abilities provided by the rubber backing 12 on the exterior of the windshield.

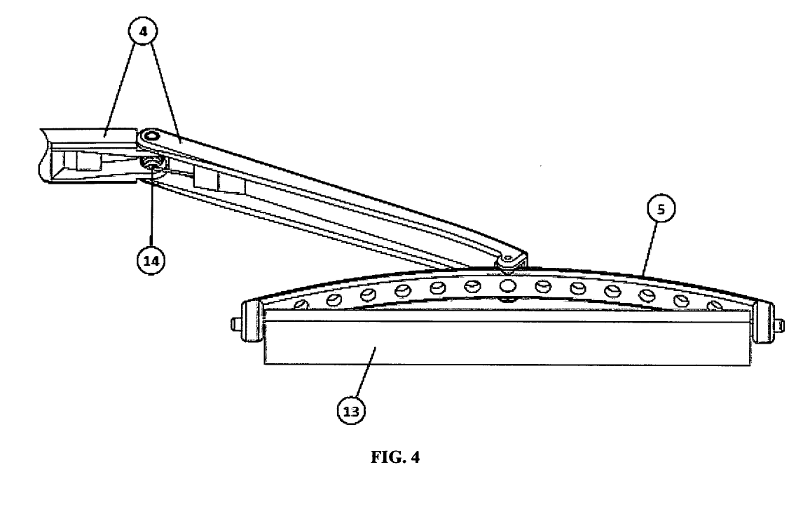

Referring to FIG. 4 of the drawings, there is shown the details of the blade assembly introduced in FIG. 1. Contained within the wiper arm 4, is a pin joint around which there is a torsion spring 14 for applying the necessary force to the blade support 5 and subsequently the blade 13. This provides for movement of the blade 13 across varying windshield contours. The wiper arm 4 and blade support 5 are also connected by a pin joint to allow for greater range of motion. The blade support 5 and blade 13 are readily available as an off-the-shelf items and not a specific inclusion of the invention; although it should be understood they are made of material and geometry such that the wiper blade 13 conforms to varying windshield geometries as the invention operates.

It can be seen that an attachable windshield wiper has been presented that can fit a variety of open canopy vehicles and clear debris and precipitation from the windshield. This provides for safer operation of open canopy vehicles with windshields if the operator should encounter inclement weather conditions—rain, snow, mud etc.

What is claimed is:

1. An attachable and detachable windshield-wiper assembly for a windshield of an open canopy vehicle comprising of a case with a rubber backing to conform to the convex face of a windshield, with a screw and/or latch system on said case that provide a means for fastening the device, a lid for protecting the internal components of said case, and a battery powered DC motor driving a gear train and linkage attached to a blade assembly protruding from said case.

2. An attachable and detachable windshield-wiper assembly for a windshield of an open canopy vehicle according to claim 1, wherein said screw and/or latch system is more specifically a knob-with-threaded-stud system which safely secures said device during operation.

3. An attachable and detachable windshield-wiper assembly for a windshield of an open canopy vehicle according to claim 1, wherein said DC motor is 4.5V and powered by the 12V battery of vehicle; they are connected through a DC voltage regulator.

4. An attachable and detachable windshield-wiper assembly for a windshield of an open canopy vehicle according to claim 1, wherein said motor is controlled by means of two in-line switches: one for activation/deactivation and another for varying the speed of operation.

5. An attachable and detachable windshield-wiper assembly for a windshield of an open canopy vehicle according to claim 1, wherein said blade assembly consists of an arm, blade support, and blade.

6. An attachable and detachable windshield-wiper assembly for a windshield of an open canopy vehicle according to claim 5, wherein said blade assembly is attached to said case and linkage by means of pin joints such that said blade assembly may move across a sufficient area of the windshield.

7. An attachable and detachable windshield-wiper assembly for a windshield of an open canopy vehicle according to claim 5, wherein said arm contains a two sections connected by a pin joint and spring to apply force to said blade support such that said blade may conform to the contours of a windshield and remove debris and precipitation.
